(19) United States
(12) Patent Application Publication
(10) Pub. No.: US 2009/0304978 A1
(43) Pub. Date: Dec. 10, 2009

(54) VEHICLE FLOOR MAT

(76) Inventor: Wei Jyh Huang, Taipei City (TW)

Correspondence Address: Dr. BANGER SHIA;Int''l Patent Office of Bang Shia, 102 Lindencrest Ct, Sugar Land, TX, 77479-5201, US

(21) Appl. No.: 12/135,959

(22) Filed: Jun. 9, 2008

(51) Int. Cl. B32B 3/26

(52) U.S. Cl. 428/69

(57) ABSTRACT

A vehicle floor mat includes an air cushioning device formed of soft plastic. The air cushioning device includes a top, a bottom, and an outer, annular portion. A sealed air chamber is defined between the top, the bottom, and the outer, annular portion, providing the air cushioning device with buffering elasticity. A mat body includes an engaging section coupled with the air cushioning device. The mat body is mounted on a floor of a vehicle, and the air cushioning device can be stepped on.

### BACKGROUND OF THE INVENTION

1. Field of the Invention

The present invention relates to a vehicle floor mat and, more particularly, to a vehicle floor mat having an air cushioning device for enhanced stepping comfort.

2. Description of the Related Art

Vehicle floor mats are generally placed on carpets on car floors to prevent the carpets from becoming dirty. The floor mats can be removed for cleaning. The floor mats generally have an anti-slipping device on a bottom thereof. A common design of the anti-slipping design includes protrusions that can be engaged in the carpets to prevent slipping of the floor mats. The floor mats can have differing designs on the top side thereof including plastic layers, naps, etc. for receiving water, snow, or dust, preventing the carpets from becoming dirty. However, stepping comfort is not considered. Specifically, the feet of the drivers will feel uncomfortable after long-term driving even though floor mats are utilized.

### BRIEF SUMMARY OF THE INVENTION

An objective of the present invention is to provide a vehicle floor mat with enhanced stepping comfort.

Another objective of the present invention is to provide a vehicle floor mat that is integrally formed to enhance integrity, stability, and convenience.

A vehicle floor mat according to the preferred teachings of the present invention includes an air cushioning device formed of soft plastic and adapted to be stepped on. The air cushioning device includes a top, a bottom, and an outer, annular portion. A sealed air chamber is defined between the top, the bottom, and the outer, annular portion, providing the air cushioning device with buffering elasticity. A mat body includes an engaging section coupled with the air cushioning device. The mat body is adapted to be mounted on a floor of a vehicle.

Preferably, the air cushioning device includes a plurality of ribs extending downward from the top and spaced from the bottom. The ribs can press against the bottom to provide support when the air cushioning device is stepped on.

Preferably, the top of the air cushioning device includes a plurality of recesses for receiving snow, rain, or dust.

Preferably, anti-slipping protrusions are formed on an upper face of the top of the air cushioning device and on an underside of the bottom of the cushioning device.

Preferably, the mat body is made of soft plastic. The outer, annular portion of the air cushioning device includes a coupling section in a peripheral portion thereof. The coupling section is integrally formed with the mat body as a single continuous monolithic piece.

Preferably, the engaging section of the mat body is located below an accelerator of the vehicle.

The present invention will become clearer in light of the following detailed description of an illustrative embodiment of this invention described in connection with the drawings.

### DESCRIPTION OF THE DRAWINGS

The illustrative embodiment may best be described by reference to the accompanying drawings where:

FIG. 1 shows a perspective view of a vehicle floor mat according to the preferred teachings of the present invention.

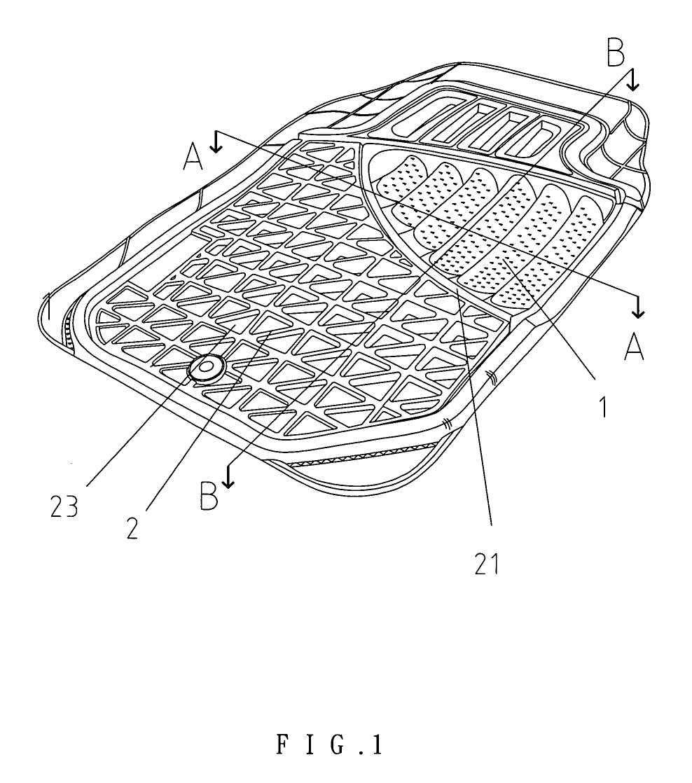

FIG. 2 shows a cross-sectional view of the vehicle floor mat of FIG. 1 according to section line A-A of FIG. 1.

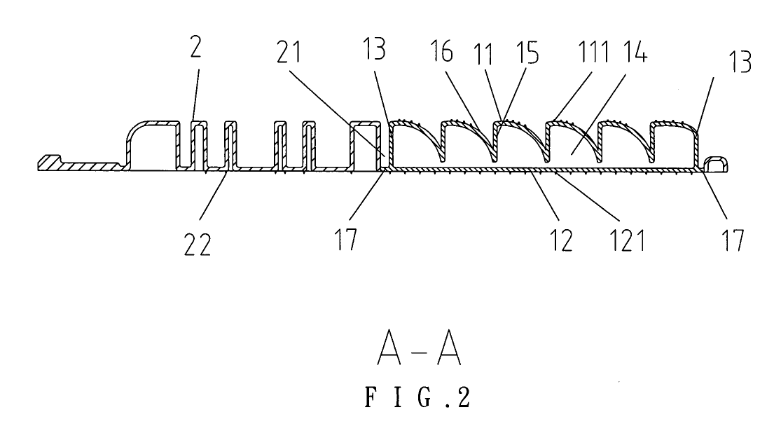

FIG. 3 shows a cross-sectional view of the vehicle floor mat of FIG. 1 according to section line B-B of FIG. 1, illustrating use of the floor mat.

All figures are drawn for ease of explanation of the basic teachings of the present invention only; the extensions of the Figures with respect to number, position, relationship, and dimensions of the parts to form the preferred embodiment will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

### DETAILED DESCRIPTION OF THE INVENTION

A vehicle floor mat according to the preferred teachings of the present invention is shown in the drawings and generally includes an air cushioning device 1 and a mat body 2. Air cushioning device 1 is made of soft plastic and includes a top 11, a bottom 12, and an outer, annular portion 13. A sealed air chamber 14 is defined between top 11, bottom 12, and annular portion 13, providing air cushioning device 1 with buffering elasticity. A plurality of spaced ribs 15 extend downward from top 11 and spaced from bottom 12. When air cushioning device 1 is stepped on, ribs 15 can come in contact with and press against bottom 12 to provide enhanced support and to prevent excessive deformation. Top 11 further includes a plurality of recesses 16 on an outer face thereof for receiving snow, water, dust, etc. Anti-slipping protrusions 111, 121 can be formed on an upper face of top 11 and an underside of bottom 12. Annular portion 13 includes a coupling section 17 at a peripheral portion thereof.

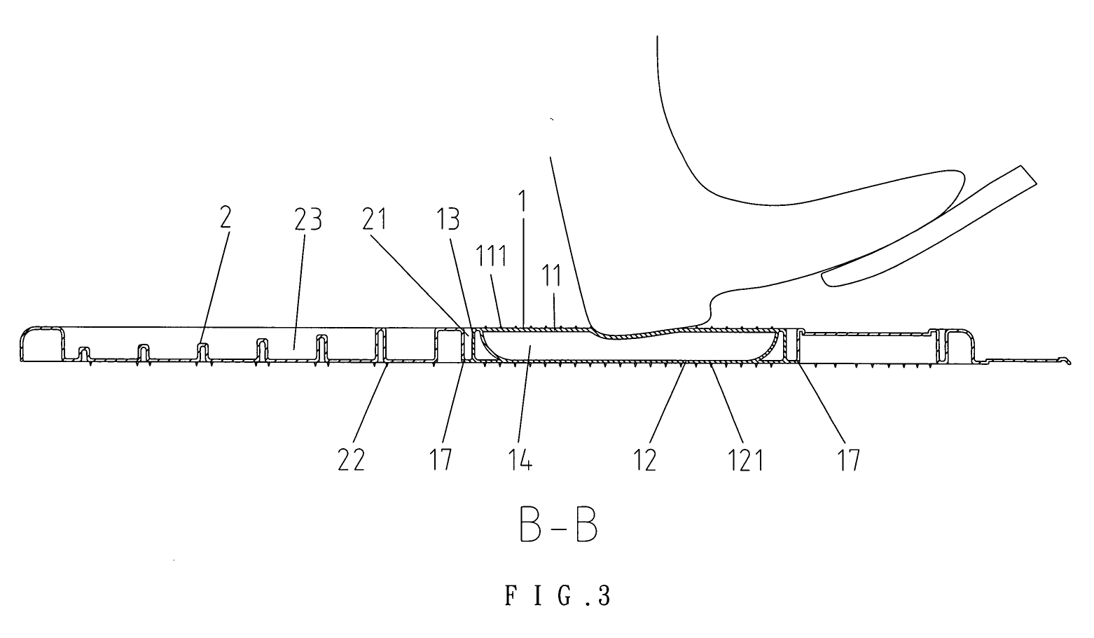

Mat body 2 is made of soft plastic. In manufacture, air cushioning device 1 is placed in a mold, and molten plastic material is filled into the mold to form mat body 2. Mat body 2 includes a hollow engaging section 21 having a perimeter integrally formed with coupling section 17 of air cushioning device 1 as a single continuous monolithic piece. Engaging portion 21 is located in a position where a foot of a user usually steps on. As an example, engaging portion 21 is located below an accelerator of a vehicle having a floor on which the floor mat is placed (FIG. 3). Anti-slipping protrusions 22 are formed on a bottom side of mat body 2. Furthermore, mat body 2 includes a plurality of grooves 23 in a top face thereof for receiving snow, water, dust etc.

Air cushioning device 1 provides enhanced stepping comfort for the foot of a driver and reduces fatigue resulting from long-term driving. The heel of the right foot of the driver can be supported by air cushioning device 1, providing enhanced comfort (FIG. 3). Ribs 15 provide enhanced support and avoid excessive deformation when air cushioning device 1 is subjected to a larger stepping force. Recesses 16 of air cushioning device 1 can receive snow, rain, and dust. Protrusions 111, 121 of top 11 and bottom 12 provide anti-slipping effect. Air cushioning device 1 is integrally formed with mat body 2 as a single continuous monolithic piece, providing convenient manufacture, structural stability, and overall quality impression.

The vehicle floor mat according to the preferred teachings of the present invention can include a plurality of cushioning devices 1. Cushioning devices 1 do not have to include ribs 15, recesses 16, protrusions 111, 121, and coupling section 17. Mat body 2 can include a plurality of engaging sections 21 for coupling with cushioning devices 1 by bonding or other suitable methods. Engaging section 21 does not have to be hollow, and the cushioning device 1 can be directly mounted on top of engaging section 21 by bonding or other suitable methods.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A vehicle floor mat comprising:
an air cushioning device formed of soft plastic and adapted to be stepped on, with the air cushioning device including a top, a bottom, and an outer, annular portion, with a sealed air chamber being defined between the top, the bottom, and the outer, annular portion, providing the air cushioning device with buffering elasticity; and
a mat body including an engaging section coupled with the air cushioning device, with the mat body being adapted to be mounted on a floor of a vehicle.

2. The vehicle floor mat as claimed in claim 1, with the air cushioning device including a plurality of ribs extending downward from the top and spaced from the bottom, and with the plurality of ribs being capable of pressing against the bottom to provide support when the air cushioning device is stepped on.

3. The vehicle floor mat as claimed in claim 1, with the top of the air cushioning device including a plurality of recesses for receiving snow, rain, or dust.

4. The vehicle floor mat as claimed in claim 1, with the top of the air cushioning device including a plurality of first anti-slipping protrusions formed on an upper face thereof, and with the bottom of the cushioning device including a plurality of second anti-slipping protrusions formed on an underside thereof.

5. The vehicle floor mat as claimed in claim 1, with the mat body being made of soft plastic, with the outer, annular portion of the air cushioning device including a coupling section in a peripheral portion thereof, and with the coupling section integrally formed with the mat body as a single continuous monolithic piece.

6. The vehicle floor mat as claimed in claim 1, with the engaging section of the mat body being adapted to be located below an accelerator of the vehicle.
